(19) United States
(12) Patent Application Publication
(10) Pub. No.: US 2004/0001722 A1
(43) Pub. Date: Jan. 1, 2004

(54) Apparatus and method of providing replacement instructions for consumable items used in an image forming apparatus

(75) Inventor: Yukihiro Nezu, Matsudo-shi (JP)

Correspondence Address: FOLEY AND LARDNER, SUITE 500, 3000 K STREET NW, WASHINGTON, DC, 20007, US

(73) Assignee: TOSHIBA TEC KABUSHIKI KAISHA

(21) Appl. No.: 10/180,322

(22) Filed: Jun. 27, 2002

(51) Int. Cl. G03G 15/08

(52) U.S. Cl. 399/27

(57) ABSTRACT

An apparatus for forming image includes: a storing unit for pre-storing explanation image data specifically explaining a method of replacing at least one or more consumable item which can be replaced by the user; a replacement time detecting unit for detecting replacement time of each of the consumable items; and an image control output unit for receiving replacement instruction information instructing replacement of the consumable item from the replacement time detecting unit when the replacement time detecting unit detects that the consumable item needs replacing, and outputting an image of explanation of the method of replacing the consumable item on the basis of the explanation image data of the method of replacing the consumable item stored in the storing unit.

### TECHNICAL BACKGROUND

The present invention relates to an apparatus and method for forming image. The invention can be applied to an apparatus and method for forming image which is assembled in, for example, a copying machine, a multifunction peripheral (MFP), a laser printer, or the like and has consumable items (such as toner, roller, and oil) that can be replaced by the user.

For example, in an apparatus for forming image using toner, an image forming process is performed by uniforming applying charges of one of polarities to the surface of a photosensitive drum, exposing the photosensitive drum with light based on image signals to form a latent image, allowing toner charged to the opposite polarity to be attracted to the photosensitive drum to produce a visible image, transferring the visible image onto a sheet of paper, and fixing the visible image.

As such an image forming process is repeatedly executed, parts constructing the apparatus for forming image wear out and toner, oil, and the like are consumed and become insufficient. It is more convenient and desirable that the user replenishes or replaces the consumable items as compared with the case that the user asks a field engineer to do it.

However, it cannot be expected that all of users understand how to replenish or replace the consumable items. For example, there are cases such that the user has never replenished or replaced the consumable items or although the user has replenished or replaced the consumable items but forgot how to do it.

For such occasions, an instruction manual describing the method of replacing consumable items is provided.

The instruction manual is, however, becoming thicker as the functions of an apparatus for forming image of recent years are becoming more complicated, so that it is difficult for the user to promptly find the right page. When the instruction manual is not provided near the apparatus for forming image, there is a problem such that the user cannot promptly refer to the manual.

When the user replenishes or replaces a consumable item without reading the instruction manual, the user may replenishes or replaces the consumable item in a wrong way. If a consumable item is replenished or replaced in such a wrong way, a load which is not expected by the designer may be applied on the peripheral parts and there is the possibility that the parts are broken.

Therefore, when the user replaces a consumable item which needs replacing, an instruction the user can easily obtain and by which the user can easily understand how to replace the consumable item is necessary.

Japanese Unexamined Patent Application No. 6-314051 discloses an apparatus for printing out information of a method of replacing a photosensitive drum at the end of its life in text form.

Generally, a photosensitive drum in a copying machine, a copying machine-based MFP, or the like is replaced by a field engineer, not by the user. In addition, explanation of the replacing method to be printed out is in the text form and is not sufficiently detailed.

Japanese Unexamined Patent Application No. 3-168765 discloses an apparatus for determining when a consumable item needs replacing on the basis of a result of counting the number of printed sheets of paper, and printing explanation of the method of replacing the consumable item at the replacing time when the capability of the display for message of a laser printer or the like is limited. Since the explanation of the replacing method intends to compensate the limited capability of the display for message, it is not sufficiently detailed.

In the above-described techniques of the literature, the explanation of the replacing method to be printed or output is not always sufficiently understandable and detailed for the user who replaces the consumable item. It is consequently a subject to print explanation of a replacing method which is sufficiently understandable to the user.

In the techniques in the literature, time to replace a photosensitive drum or the like is determined on the basis of the number of revolutions of the photosensitive drum, the number of sheets printed, and the like. Specifically, the replacement time is determined on the basis of indirect factors such as the number of revolutions of the photosensitive drum and the number of sheets printed, and explanation of the replacement method is printed or output. It is therefore a subject to determine the replacement time on the basis of accurate life of a consumable item.

### SUMMARY OF THE INVENTION

An object of the invention is to enable consumable items (such as a toner, a roller, and oil) which can be replaced by the user of an apparatus for forming image to be replaced more simply and accurately.

An apparatus for forming image of the invention has been made to achieve the object and is characterized by including: a storing unit for pre-storing explanation image data for specifically explaining a method of replacing at least one consumable item which can be replaced by the user; a replacement time detecting unit for detecting replacement time of each of the consumable items; and an image control output unit for receiving replacement instruction information instructing replacement of the consumable item from the replacement time detecting unit when the replacement time detecting unit detects that the consumable item needs replacing, and outputting an image of explanation of a method of replacing the consumable item on the basis of the explanation image data of the method of replacing the consumable item stored in the storing unit.

A method for forming image of the invention has been made to achieve the object and is characterized in that a storing unit pre-stores explanation image data for specifically explaining a method of replacing at least one or more consumable item which can be replaced by the user, a replacement time detecting unit detects replacement time of each of the consumable items, and an image control output unit receives replacement instruction information instructing replacement of the consumable item from the replacement time detecting unit when the replacement time detecting unit detects that the consumable item needs replacing, and outputs an image of explanation of a method of replacing the consumable item on the basis of the explanation image data of the method of replacing the consumable item stored in the storing unit.

According to the invention, even if the user does not know the details of a method of replacing a consumable item or the place where an instruction manual describing the replacing method is, the user can easily obtain understandable detailed explanation of the replacing method.

According to the invention, when the user does not need explanation, the explanation is not printed. Consequently, the apparatus for forming image according to the invention does not have to output the explanation of the method of replacing a consumable item to the user who knows the details of the replacing method.

Further, according to the invention, the apparatus for forming image according to the invention can directly detect when a consumable item needs replacing. Thus, the user can replace the consumable item in accurate replacement time.

### BRIEF DESCRIPTION OF THE DRAWINGS

FIG. 1 is a flowchart showing operations of displaying and printing explanation of a toner replenishing method in an apparatus for forming image according to the invention;

FIG. 2 is a diagram for explaining a display screen displayed by a display/input device according to the embodiment; and

FIG. 3 is a block diagram showing the internal configuration of an apparatus for forming image according to the embodiment.

### BEST MODE FOR CARRYING OUT THE INVENTION

An embodiment of an apparatus for forming image according to the invention will be described hereinbelow. The embodiment relates to an apparatus for forming image which is assembled in a copying machine-based multifunction peripheral and uses toner, and is applied to the case of replenishing toner used for an image forming process.

FIG. 3 is a block diagram showing the internal configuration of the apparatus for forming image according to the embodiment.

As shown in FIG. 3, an apparatus for forming image 1 has a scanner 2, a forming image control unit 3, an image memory 4, an electrophotographic device 5, and a display/input device 11. The internal configuration of the apparatus for forming image 1 will be described hereinbelow.

The scanner 2 reads an original of an image and supplies read data to the forming image control unit 3.

The forming image control unit 3 controls an image forming process of the copying machine 1. The forming image control unit 3 receives the read data from the scanner 2, converts the read data into print data which can be printed, and supplies the converted print data to the electrophotographic device 5. The forming image control unit 3 also supplies, as necessary, the print data which is used many times to the image memory 4 so as to be stored. Further, the forming image control unit 3 is connected to a printer controller 12, receives image data generated by a user terminal (PC) 13 and supplies the image data to the electrophotographic device 5.

The forming image control unit 3 also receives toner near-empty detection information indicating that the residual amount of toner in a toner cartridge 7 became small or toner empty detection information from a residual amount detecting device 8 which will be described hereinlater, and instructs the display input device 11 to display a message that replenishment of toner to the toner cartridge 7 is required. The forming image control unit 3 also instructs the display/input device 11 to display a message that replenishment of toner to the toner cartridge 7 is required and whether the user wants to print explanation of a toner replenishing method or not. The forming image control unit 3 receives selection of the user regarding whether the user desires the printing of explanation of the toner replenishing method or not from the display input device 11, and controls output of the explanation of the toner replenishing method in accordance with the user selection instruction. In the case of outputting the explanation of the toner replenishing method, the forming image control unit 3 gives an instruction to read explanation data (image data) of the toner replenishing method prestored in a registration area of the image memory 4 and to print the explanation data of the toner replenishing method.

The image memory 4 receives the print data from the forming image control unit 3 and stores the print data. The image memory 4 has the registration area for storing registration data which is pre-registered. In the registration area, image data which is used many times, data of explanation of handling of the apparatus for forming image, and the like can be stored. That is, in the registration area, the explanation of the method of replenishing toner of the toner cartridge 7 is stored as data. The data of explanation of the toner replenishing method stored is not limited to the text form but may include image data such as an illustration. In the image memory 4, data to be stored is registered in the form of an electronic document. When it is detected that the residual amount of toner in the toner cartridge 7 became small and the user wants the toner replenishing method to be printed, the image memory 4 receives an instruction from the forming image control unit 3, reads out the explanation data of the toner replenishing method stored in the registration area, and supplies it to the forming image control unit 3.

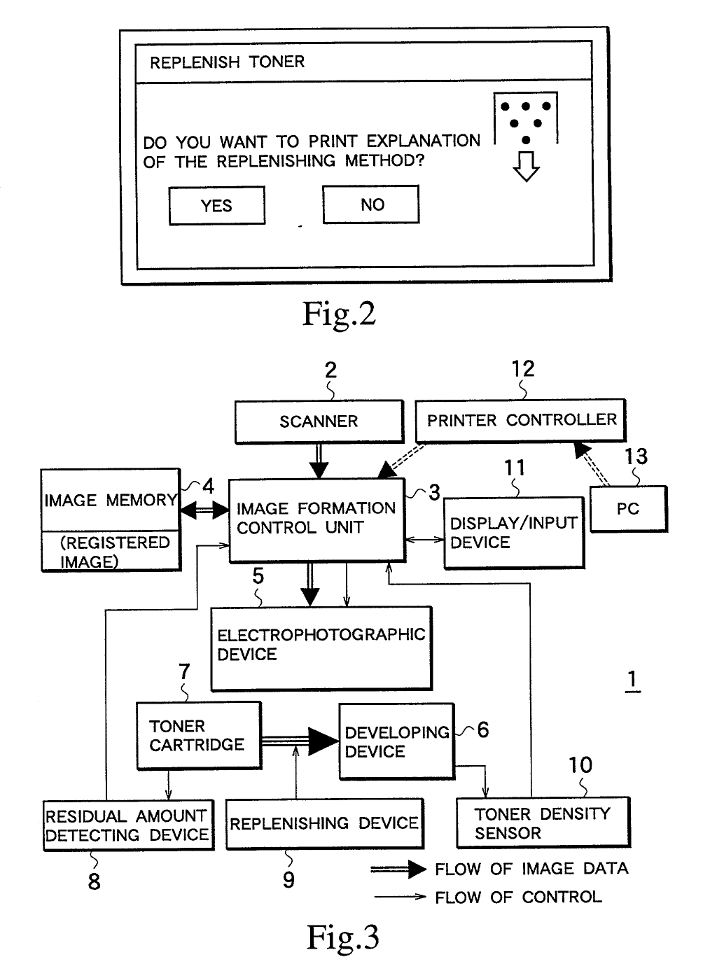

The display/input device 11 displays information regarding forming image under control of the forming image control unit 3. The display/input device 11 receives an instruction given by the user on the basis of information regarding forming image displayed, and the like. The display input device 11 can be apply to, for example, a touch panel type. When an icon (image) displayed is touched by the user, a selected input instruction may be given to the forming image control unit 3. When it is detected that the toner residual amount in the toner cartridge 7 became small, the display/input device 11 receives an instruction from the forming image control unit 3 and displays a message requiring toner replenishment as shown in FIG. 2.

FIG. 2 shows an example of the message of a toner replenishment request which can be displayed on the display/input device 11. As shown in FIG. 2, on the display screen, the message that the toner residual amount became small is displayed and also a message inquiring the user of whether the user desires explanation of the toner replenishing method to be printed or not can be also displayed. The display/input device 11 receives the selection information entered by the user and supplies the selection information to the forming image control unit 3.

The printer controller 12 receives an image generated by the user terminal (PC) and supplies the image to the forming image control unit 3.

The forming image control unit 3 can receive the image from the printer controller 12 and convert the image into print data. Although the forming image control unit 3 receives images from both the scanner 2 and the printer controller 12 in the embodiment, it is obvious that an image may be received from one of the devices.

The electrophotographic device 5 charges a photosensitive drum (not shown), exposes the photosensitive drum with light on the basis of the print data received from the forming image control unit 3, allows toner to be attracted to a latent image formed by the exposure so as to form a visible image, and transfers the visible image onto a sheet of paper.

The functions of the internal configuration of the electrophotographic device 5 will be described hereinbelow and a process of detecting toner replenishment will be particularly described in detail.

As shown in FIG. 3, the electrophotographic device 5 has, at least, a developing device 6, the toner cartridge 7, the residual amount detecting device 8, a replenishing device 9, and a toner density sensor 10.

The developing device 6 makes toner received from the toner cartridge 7 attracted to a formed latent image, thereby producing a visible image. The developing device 6 allows the toner density sensor 10 which will be described hereinlater to measure the density of the toner adhered to the formed visible image. Although not shown in FIG. 3, the visible image formed by the developing device 6 is transferred onto a sheet of paper, fixed, and output.

The toner cartridge 7 contains the toner. When the developing device 6 makes the toner adhere on the latent image on the photosensitive drum, the toner cartridge 7 supplies the toner to the developing device 6 while the amount of the toner is adjusted to be constant by the replenishing device 9. The toner in the toner cartridge 7 is consumed according to the use frequency such as the number of copied sheets or the like of the developing device 6. In the present embodiment, the toner cartridge is used as the container of the toner. Alternately, a bottle may be used. The toner cartridge, bottle, and the like which are conventionally used can be applied. The type of toner may be dry or wet. The residual toner amount contained in the toner cartridge 7 is monitored by the residual amount detecting device 8.

The replenishing device 9 adjusts the amount of toner supplied from the toner cartridge 7 to the developing device 6 to be constant. As the replenishing device 9, various types can be applied as long as they can make the density of toner contained in the toner cartridge 7 constant and supply a predetermined amount of the toner to the developing device 6.

The residual amount detecting device 8 detects the residual amount of the toner contained in the toner cartridge 7. The residual amount detecting device 8 is a toner residual amount sensor attached to the toner cartridge 7. As the residual amount detecting device 8, for example, a magnetic sensor, an optical sensor, and the like can be applied. When the residual amount of the toner contained in the toner cartridge 7 becomes small, the residual amount detecting device 8 supplies toner near-empty detection information to the forming image control unit 3. When the toner becomes empty, the residual amount detecting device 8 supplies toner empty detection information to the forming image control unit 3. In the embodiment, detection information of two stages of the toner near-empty detection information and the toner empty detection information is supplied to the forming image control unit 3. Alternately, detection information of three, four, and more stages can be supplied.

The toner density sensor 10 measures the density of toner adhered to the latent image of the photosensitive drum in the developing device 6. The toner density sensor 10 measures the amount of toner adhered to the photosensitive drum and adjusts the amount of toner under control of the forming image control unit 3, thereby maintaining the density of toner adhered to be constant.

An operation of printing explanation of the toner replenishing method in the apparatus for forming image according to the embodiment will now be described.

First, an image is read by the scanner 2 and the read data is supplied to the forming image control unit 3.

The read data from the scanner 2 is converted to print data which can be printed in the forming image control unit 3, and the print data is supplied to the electrophotographic device 5. If the print data is data which is used many times, the print data is supplied from the forming image control unit 3 to the image memory 4 and stored in the registration area in the image memory 4.

The print data from the forming image control unit 3 is supplied to the electrophotographic device 5. In the developing device 6, toner from the toner cartridge 7 is adhered to a latent image formed on the photosensitive drum to produce a visible image. At this time, the amount of toner adhered to the photosensitive drum is adjusted by the replenishing device 9. The amount of toner adhered to the latent image is adjusted so that the toner density becomes constant by the toner density sensor 10.

The visible image formed is transferred onto a sheet of paper and fixed, and the sheet of paper on which the image is formed is ejected.

As such an image forming process is performed, the toner contained in the toner cartridge 7 is consumed and the toner residual amount decreases.

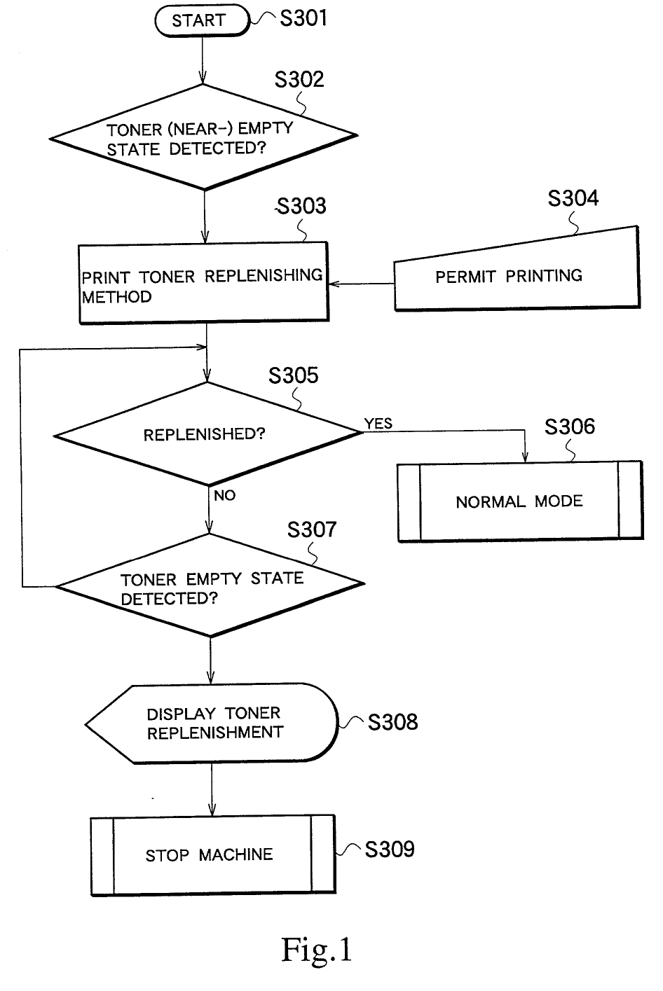

FIG. 1 is a flowchart showing the operations of displaying and printing the explanation of the toner replenishing method of the forming image control unit 3.

The residual amount of toner in the toner cartridge 7 is detected by the residual amount detecting device 8. When it is detected that the residual amount of toner in the toner cartridge 7 became small, the toner near-empty detection information is supplied from the residual amount detecting device 8 to the forming image control unit 3 (S302).

When the toner near-empty detection information from the residual amount detecting device 8 is supplied to the forming image control unit 3, the forming image control unit 3 instructs the display/input device 11 to display a message that the toner residual amount became small, and information of a request for toner replenishment as shown in FIG. 2 is displayed on the display/input device 11.

Together with the information of the request for toner replenishment, a selection display screen for allowing the user to select whether the explanation of the toner replenishing method is printed or not is also displayed on the display/input device 11.

For example, as shown in FIG. 2, both of a message “replenish toner” addressing the state that the toner residual amount became small and a message “Do you want to print explanation of the replenishing method?” to allow the user to select whether the explanation of the toner replenishing method is printed or not are displayed on the display/input device 11. Options of “YES” and “NO” for the question of whether the explanation of the toner replenishing method is printed or not are also displayed.

The screen displayed may include, as shown in FIG. 2, a figure or illustration to let the user know that toner replenishment is required.

When the request for toner replenishment and the options of printing of the toner replenishing method explanation are displayed on the display/input device 11, whether the explanation of the toner replenishing method is printed or not is selected by the user, and the selection information is supplied to the forming image control unit 3 (S303).

The display/input device 11 may have a display unit and an input unit separately or may be of a touch panel type which supplies selection information to the forming image control unit 3 when a displayed selection image is pressed (touched) by the user. For example, in the case where the display/input device 11 is of the touch panel type, when “YES” in the selection display screen shown in FIG. 2 is selected by the user, the selection information is supplied to the forming image control unit 3 via the display input device 11 (S304).

When “YES” indicating that the user wants the explanation of the toner replenishing method to be printed is selected, the forming image control unit 3 controls so that the explanation of the toner replenishing method is printed.

The instruction of reading the explanation data of the toner replenishing method is given from the forming image control unit 3 to the image memory 4 and the explanation data (print data) of the toner replenishing method stored in the registration area in the image memory 4 is read out.

The read explanation data of the toner replenishing method is supplied to the electrophotographic device 5. By executing the image forming process on the basis of the explanation data of the toner replenishing method, the explanation of the toner replenishing/replacing method is printed.

Specifically, based on the explanation data of the toner replenishing method, toner is allowed to be adhered on a latent image formed on the photosensitive drum to produce a visible image. The image is printed on a sheet of paper and the printed sheet is ejected.

The explanation of the toner replenishing method to be printed is not limited to the text form but may include an image such as illustration, diagram (for example, diagram of devices used to exchange the toner cartridge 7), flowchart for easier understanding of the toner replenishing method.

For example, when “NO” in the selection display shown in FIG. 2 is selected by the user, the selection information is supplied to the forming image control unit 3 via the display/input device 11 but the explanation of the toner replenishing/replacing method is not printed (S304).

After that, the user replenishes toner with reference to the printed explanation of the toner replenishing method or by his/her way without referring to the explanation. Whether the toner has been replenished or not is determined by the forming image control unit 3 on the basis of the result of detection of the residual amount detecting device 8 (S305).

When it is determined that replacement of the toner cartridge 7 has been finished by the forming image control unit 3, the program returns to the normal mode and the image forming process is continued (S306).

When it is determined by the forming image control unit 3 that replacement of the toner cartridge 7 has not been finished yet, the program does not return to the normal mode until toner is replenished.

The toner empty detection information from the residual amount detecting device 8 is continuously supplied to the forming image control unit 3 until the toner replenishment is finished. When toner is not replenished in spite of the information and the toner is completely finished, a message of a request for toner replenishment is displayed on the display/input device 11 by an instruction of the forming image control unit 3 (S308).

If toner is not replenished in spite of the message, forming image cannot be performed and the printing operation of the copying machine 1 itself is stopped by an instruction of the forming image control unit 3 (S309).

In such a manner, the explanation of the toner replenishing method is printed by the image forming process according to the embodiment.

In the embodiment, the explanation of the toner replenishing method printed is not limited to explanation of only the method of simply replacing the toner cartridge 7. For example, telephone number of a service station for providing maintenance on the copying machine 1 and the like may be also printed.

Although the case of printing the explanation of the method of replenishing toner used for the copying machine 1 has been described in the embodiment, the invention is not limited to the toner but can be also applied to a method of replacing a consumable item (such as a roller or oil) which can be replaced by the user.

For example, in the case of replacing a roller, the roller may be any of rollers in the copying machine 1, and explanation of a replacing method of each roller is stored in the registration area in the image memory 4.

Further, although the case where the apparatus for forming image is assembled in the copying machine 1 has been described in the foregoing embodiment, the invention is not limited to the copying machine but can be also applied to an apparatus for forming image in another device such as a facsimile machine, a printer, or a multifunction peripheral.

What is claimed is:

1. An apparatus for forming image comprising:
a storing unit for pre-storing explanation image data for specifically explaining a method of replacing at least one or more consumable item which can be replaced by the user;
a replacement time detecting unit for detecting replacement time of each of said consumable items; and
an image control output unit for receiving replacement instruction information instructing replacement of the consumable item from said replacement time detecting unit when said replacement time detecting unit detects that the consumable item needs replacing, and outputting an image of explanation of a method of replacing the consumable item on the basis of the explanation image data of the method of replacing the consumable item stored in said storing unit.

2. The apparatus for forming image according to claim 1, wherein said image control output unit outputs explanation image data in the same output form as that of image data which is output by a normal image forming process on the basis of the replacement instruction information from said replacement time detecting unit.

3. The apparatus for forming image according to claim 1, further comprising a display/input unit for displaying at least a selection screen of whether or not an image of detailed explanation of the method of replacing the consumable item is printed or not when said replacement time detecting unit detects that the consumable item needs replacing, and receiving selection information inputted by the user,
wherein said image control output unit controls forming of an image of detailed explanation of the method of replacing the consumable item when selection information indicating that printing is requested is received from said display/input unit.

4. The apparatus for forming image according to claim 1, wherein the image of detailed explanation of the method of replacing a consumable item output from said image control output unit includes an illustration or an explanation diagram.

5. The apparatus for forming image according to claim 1, wherein said consumable item which can be replaced by the user is toner.

6. A method for forming image wherein
a storing unit pre-stores explanation image data for specifically explaining a method of replacing at least one or more consumable item which can be replaced by the user, a replacement time detecting unit detects replacement time of each of said consumable items, and an image control output unit receives replacement instruction information instructing replacement of the consumable item from said replacement time detecting unit when said replacement time detecting unit detects that the consumable item needs replacing, and outputs an image of explanation of a method of replacing the consumable item on the basis of the explanation image data of the method of replacing the consumable item stored in said storing unit.

7. The method for forming image according to claim 6, wherein said image control output unit outputs explanation image data in the same output form as that of image data which is output by a normal image forming process on the basis of the replacement instruction information from said replacement time detecting unit.

8. The method for forming image according to claim 6, wherein a display/input unit is further provided for displaying at least a selection screen of whether or not an image of detailed explanation of the method of replacing the consumable item is printed or not when said replacement time detecting unit detects that the consumable item needs replacing, and receiving selection information entered by the user, and
said image control output unit controls forming of an image of detailed explanation of the method of replacing the consumable item when selection information indicating that printing is requested is received from said display/input unit.

9. The method for forming image according to claim 6, wherein the image of detailed explanation of the method of replacing a consumable item output from said image control output unit includes an illustration or an explanation diagram.

10. The method for forming image according to claim 6, wherein said consumable item which can be replaced by the user is toner.
